(19) United States
(12) Patent Application Publication
(10) Pub. No.: US 2013/0179273 A1
(43) Pub. Date: Jul. 11, 2013

(54) COMMUNICATION SYSTEM, APPARATUS AND METHOD THEREOF

(71) Applicant: Chris Chang, Union City, CA (US)

(72) Inventor: Chris Chang, Union City, CA (US)

(73) Assignee: CONNECTION PORTAL, INC., Union City, CA (US)

(21) Appl. No.: 13/594,874

(22) Filed: Aug. 27, 2012

Related U.S. Application Data
(60) Provisional application No. 61/585,634, filed on Jan. 11, 2012.

(30) Foreign Application Priority Data
May 4, 2012 (TW) 101115973

(51) Int. Cl. G06Q 30/02

(52) U.S. Cl. 705/14.69

(57) ABSTRACT

A communication system, apparatus and method thereof are provided. The system includes a connection processing server, an advertisement server, and a communication apparatus. The communication apparatus, which is connected to the connection processing server and the advertisement server, transmits an advertisement request to the advertisement server and receives an advertisement information from the advertisement server, wherein the advertisement information includes an advertisement list and a plurality of advertisement contents corresponding to the advertisement list. When the communication apparatus displays the advertisement list and an operating signal is received by the communication apparatus, the communication apparatus displays one of the advertisement contents corresponding to the operating signal, and transmits a view-ad request to the advertisement server. When the advertisement server receives the view-ad request, the advertisement server transmit an account credit request to the connection processing server to update a account balance corresponding to the communication apparatus.

### CROSS-REFERENCE TO RELATED APPLICATION

This application claims the priority benefits of U.S. provisional application Ser. No. 61/585,634, filed on Jan. 11, 2012 and Taiwan application serial no. 101115973, filed on May 4, 2012. The entirety of each of the above-mentioned patent applications is hereby incorporated by reference herein and made a part of this specification.

### BACKGROUND OF THE INVENTION

1. Technical Field

The invention relates generally to a communication system, apparatus, and method thereof. More particularly, the invention relates to a communication billing system, apparatus, and method thereof.

2. Related Art

With the continuous advancement of technology, the demands from consumers for handheld communication devices have also been increasing. Due to the rapid development of the smartphone in recent years, people are becoming ever more reliant on mobile phones. Typically speaking, a primary function of handheld communication devices such as the mobile phone is the phone call, and secondly running application programs employing data transmission on the Internet. Besides communicating over the mobile telecommunication network, calling may be performed on Voice over Internet Protocol (VoIP) with specialized application programs.

Due to features such as low call cost, low infrastructure cost, ease of scalability, and increasingly favorable call quality, VoIP has been noted by many telecommunication providers as one of the main developments in the future and a major business competitor.

VoIP typically employs Session Initiation Protocol (SIP) for call control, combined with protocols such as Real-time Transport Protocol (RTP) and Real-time Transport Control Protocol (RTCP) for the transmission of audio and video data.

VoIP may also connect and communicate with heterogeneous networks such as the mobile communication network or the Public Switched Telephone Network (PSTN) through the VoIP network and gateway. When connecting with heterogeneous networks, the fees set forth by the system providers of the heterogeneous networks must be paid. Due to one of the features of VoIP being the low call cost, providing a cost effective communication service for the users regardless of the called party is one of the issues that needs to be resolved.

### SUMMARY OF THE INVENTION

Accordingly, the invention provides a communication system, apparatus, and method thereof capable of lowering call fees by a user viewing advertisement contents.

The invention provides a communication system, comprising a connection processing server, an advertisement server, and a communication apparatus. The communication apparatus is connected to the connection processing server and the advertisement server, and the communication apparatus is configured for setting up a call through the connection processing server, and receiving an advertisement information from the advertisement server. The advertisement information includes an advertisement list and a plurality of advertisement contents corresponding to the advertisement list. When the communication apparatus displays the advertisement list and receives a first operating signal, the communication apparatus displays one of the advertisement contents corresponding to the first operating signal and transmits a view-ad request to the advertisement server. When the advertisement server receives the view-ad request, the advertisement server transmits an account credit information according to the view-ad request to the connection processing server to updates a account balance and activities corresponding to the communication apparatus.

The invention provides a communication apparatus, comprising a touch display unit, a communication unit, and a control unit. The communication unit is connected to the connection processing server. The control unit is connected to the communication unit and the touch display unit. Moreover, the control unit is connected to the connection processing server and an advertisement server through the communication unit. The control unit transmits an advertisement request to the advertisement server and receives an advertisement information from the advertisement server, wherein the advertisement information includes an advertisement list and a plurality of advertisement contents corresponding to the advertisement list. When the control unit controls the touch display unit to display the advertisement list, and the control unit receives the first operating signal from the touch display unit, the control unit displays one of the advertisement contents corresponding to the first operating signal, and transmits a view-ad request to the advertisement server so as to update a account balance and activities corresponding to the communication apparatus.

The invention provides a communication method including the following steps. An advertisement request is transmitted to the an advertisement server, and an advertisement information is received from an advertisement server, in which the advertisement information includes an advertisement list and a plurality of advertisement contents corresponding to the advertisement list. When the advertisement list is displayed in a touch display unit, and a first operating signal is received from the touch display unit, one of the advertisement contents corresponding to the first operating signal is displayed, and a view-ad request is transmitted to the advertisement server in order to update a account balance and view-ad activity credit.

In summary, embodiments of the invention provide a communication system, apparatus, and method thereof capable of displaying the advertisement list with the communication apparatus. When the user select one of the advertisement in the advertisement list through the touch display unit, the communication apparatus displays the corresponding advertisement content, and the view-ad event corresponding to the communication apparatus is simultaneously updates.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute as part of this specification. The drawings illustrate embodiments of the invention and, together with the description, serve to explain the principles of the invention.

FIGS. 1 and 2 are timing flow diagrams of a communication system according to an embodiment of the invention.

FIG. 3 is a timing flow diagram of an outbound call setup according to an embodiment of the invention.

FIG. 4 is a timing flow diagram of an inbound call setup according to an embodiment of the invention.

FIG. 5 is a timing flow diagram for updating the account balance according to an embodiment of the invention.

FIG. 6 is a block diagram of a communication apparatus according to an embodiment of the invention.

FIG. 7 is a flow diagram of a communication method according to an embodiment of the invention.

FIGS. 8A, 8B, and 8C illustrate implementations to display an advertisement list and an advertisement information according to an embodiment of the invention.

### DESCRIPTION OF EMBODIMENTS

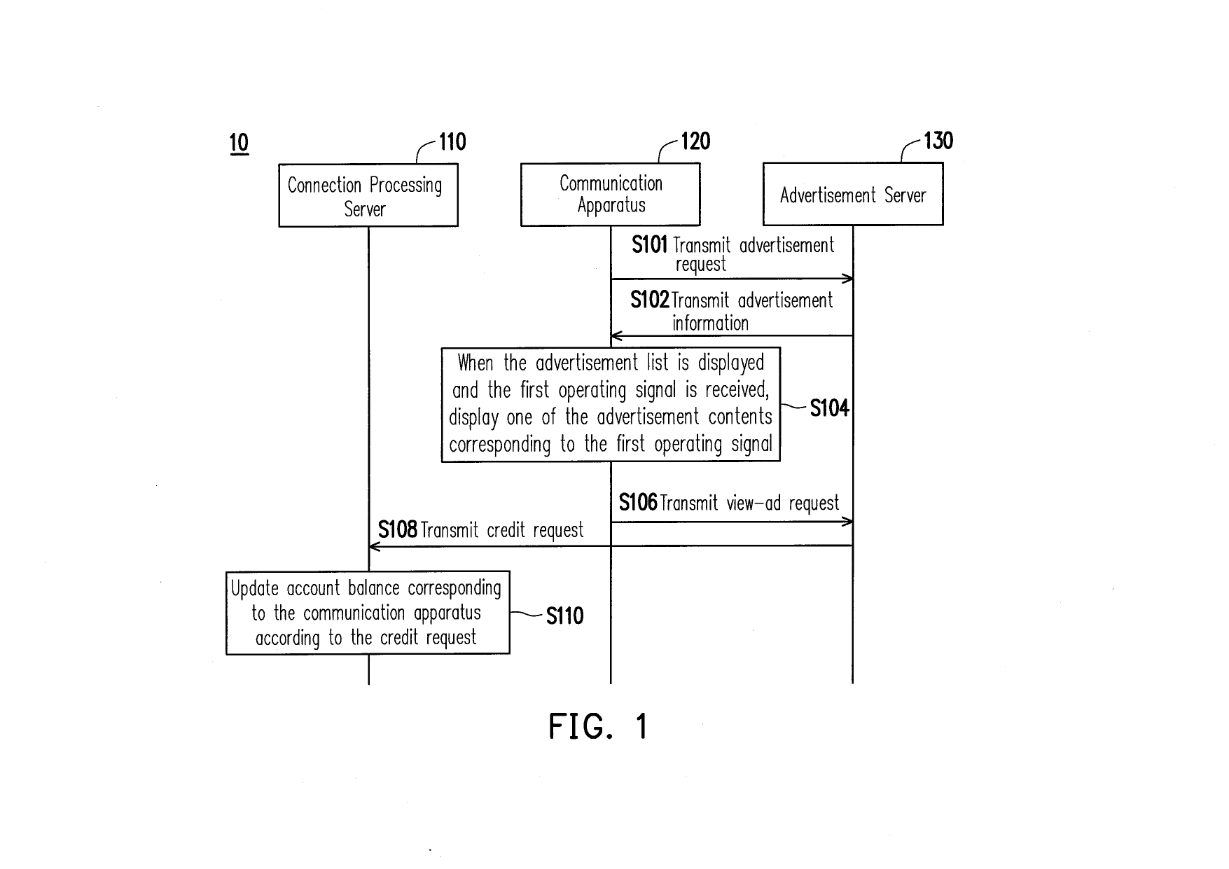

FIG. 1 is a timing flow diagram of a communication system according to an embodiment of the invention. With reference to FIG. 1, a communication system 10 includes a connection processing server 110, a communication apparatus 120, and an advertisement server 130. The communication apparatus 120 is connected to the connection processing server 110 and the advertisement server 130. The communication apparatus 120 sends an advertisement request to the advertisement server 130 (Step S101) and receives an advertisement information from the advertisement server 130. The advertisement information includes an advertisement list and a plurality of advertisement contents corresponding to the advertisement list (Step S102). When the communication apparatus 120 displays the advertisement list and receives a first operating signal, such as receiving a user operation from a touch display unit (not drawn), the communication apparatus 120 displays one of the advertisement contents corresponding to the first operating signal, for example the advertisement content corresponding to one of the options chosen by the user on the advertisement list (Step S104).

Simultaneously, the communication apparatus 120 transmits a view-ad request to the advertisement server 130 (Step S106). After the advertisement server 130 receives the view-ad request, an account crediting request is transmitted to the connection processing server 110 according to the view-ad request (Step S108). When the connection processing server 110 receives the account crediting request, the connection processing server 110 updates an account balance and credit-back transaction corresponding to the communication apparatus 120 according to the credit request event. (Step S110). In other words, whenever the user selects an advertisement from the advertisement list using the communication apparatus 120 (receiving the first operating signal), the credit corresponding to the communication apparatus 120 stored in the connection processing server 110 can be updated.

In the present embodiment, the connection processing server 110 is connected to a plurality of external devices (not drawn) through a plurality of networking methods. The communication apparatus 120 can connect and call external devices also using VoIP protocols, such as the Session Initiation Protocol (SIP) through the connection processing server 110. Moreover, the communication apparatus 120 can connect and call external devices employing heterogeneous networks such as the mobile communication network or the Public Switched Telephone Network (PSTN) through the connection processing server 110. In the present embodiment, the credit recorded in the connection processing server 110 can be applied to the service fees of calls connected through the heterogeneous networks that need to be paid. In other embodiments, the credit records in connection processing server 110 can also be applied to the balance of other fees, such as the internal data transmission fee through the telecommunication networks, the invention is not limited to the aforementioned implementations.

It should be noted that, the content of the steps executed by the connection processing server 110 may be accomplished by a combination of independently configured servers. For example, by performing their respective functions, a connection server setting up the call and monitoring call connection status, and a billing server keeps call duration records can respectively execute the steps performed by the connection processing server 110. Therefore, the invention is not limited to the aforementioned implementations.

The advertisement list includes a plurality of advertisement options. Besides each advertisement option respectively having a plurality of corresponding advertisement contents, each advertisement option also corresponds to a credit point information. When the user selects one of the advertisement options, the communication apparatus 120 can execute the aforementioned Step S104 and include credit point information and activity duration corresponding to the advertisement content in the view-ad request and transmit the view-ad request to the advertisement server 130. The advertisement server 130 authenticates the view-ad request, generates the account credit request according to the credit point and activity duration included in the view-ad request, and transmits the credit request to the connection processing server 110. The connection processing server 110 can update the account balance and credit record corresponding to the communication apparatus 120 according to the credit point and activity duration in the credit request, and thereby lower the service fees that the user of the communication apparatus 120 needs to pay. A call referred to herein can be divided into an outbound call and an inbound call, and the implementations of the two call modes are described with figures below.

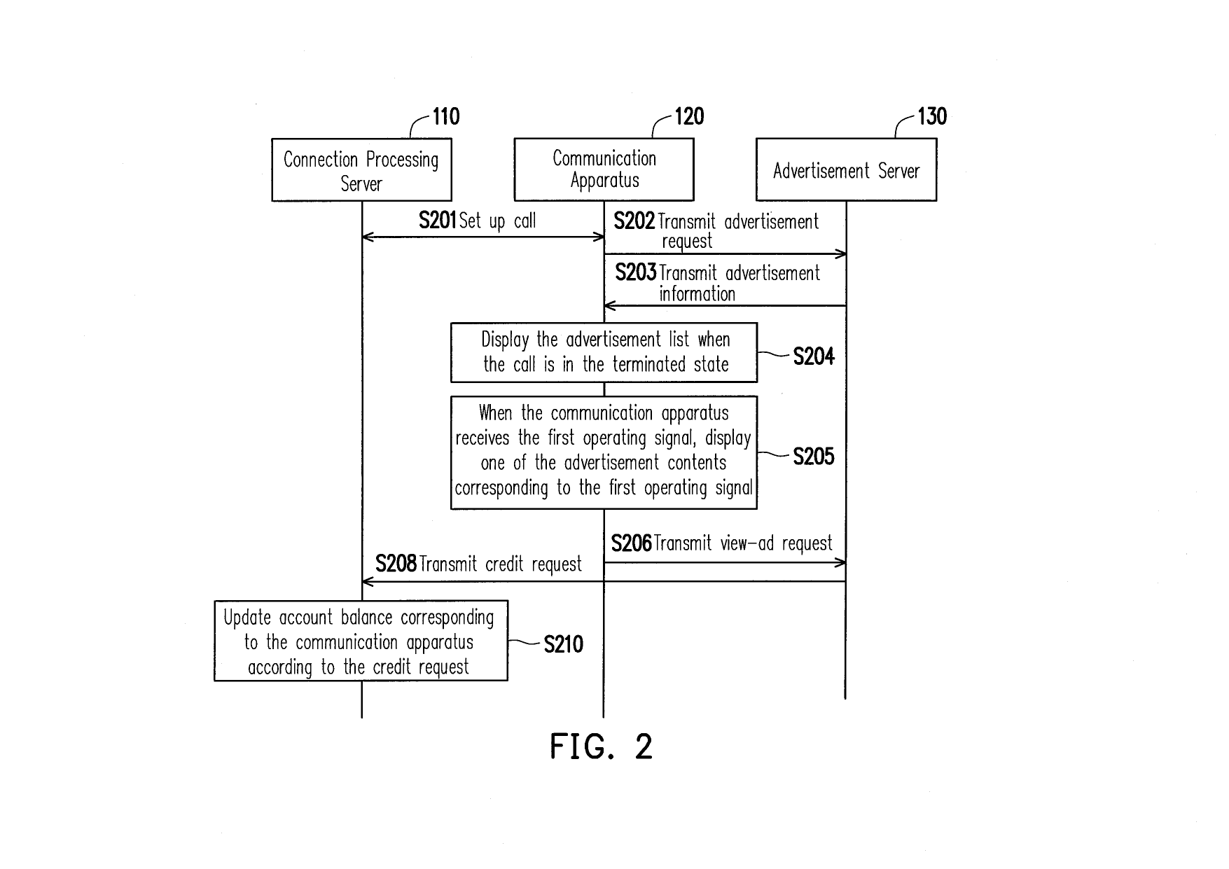

FIG. 2 is a timing flow diagram of a communication system according to an embodiment of the invention. A difference between the embodiments depicted in FIG. 2 and FIG. 1 is that, in the embodiment set forth in FIG. 1, the advertisement list can be displayed in the touch display unit of the communication apparatus at any time, whereas in the embodiment set forth in FIG. 2, the advertisement list pops up after each call has been terminated. The actual implementation in accordance with a practical scenario may be a combination of the contents described by the embodiments of FIGS. 1 and 2, and so the invention is not limited to afore-described.

Continuing reference to FIG. 2, the communication apparatus 120 sets up a call with an external communication device through the connection processing server 110 (Step S201). Moreover, the communication apparatus 120 sends an advertisement request to the advertisement server 130 (Step S202) and receives an advertisement information from the advertisement server 130 (Step S203). When the call from the communication apparatus 120 is in a terminated state, such as due to a call setup failure or a call got hung up, the communication apparatus 120 displays the advertisement list (Step S204). After the communication apparatus 120 displays the advertisement list and receives the first operating signal, the communication apparatus 120 displays one of the advertisement contents corresponding to the first operating signal (Step S205).

After communication apparatus 120 displays one of the advertisement contents corresponding to the first operating signal, the communication apparatus 120 transmits the view-ad request to the advertisement server 130 (Step S206). The advertisement server 130 authenticates the view-ad request and transmits the account crediting request to the connection processing server 110 according to the credit point and activity duration in the view-ad request (Step S208). When the connection processing server 110 receives the credit request, the connection processing server 110 updates the account balance corresponding to the communication apparatus 120 according to the credit request (Step S210).

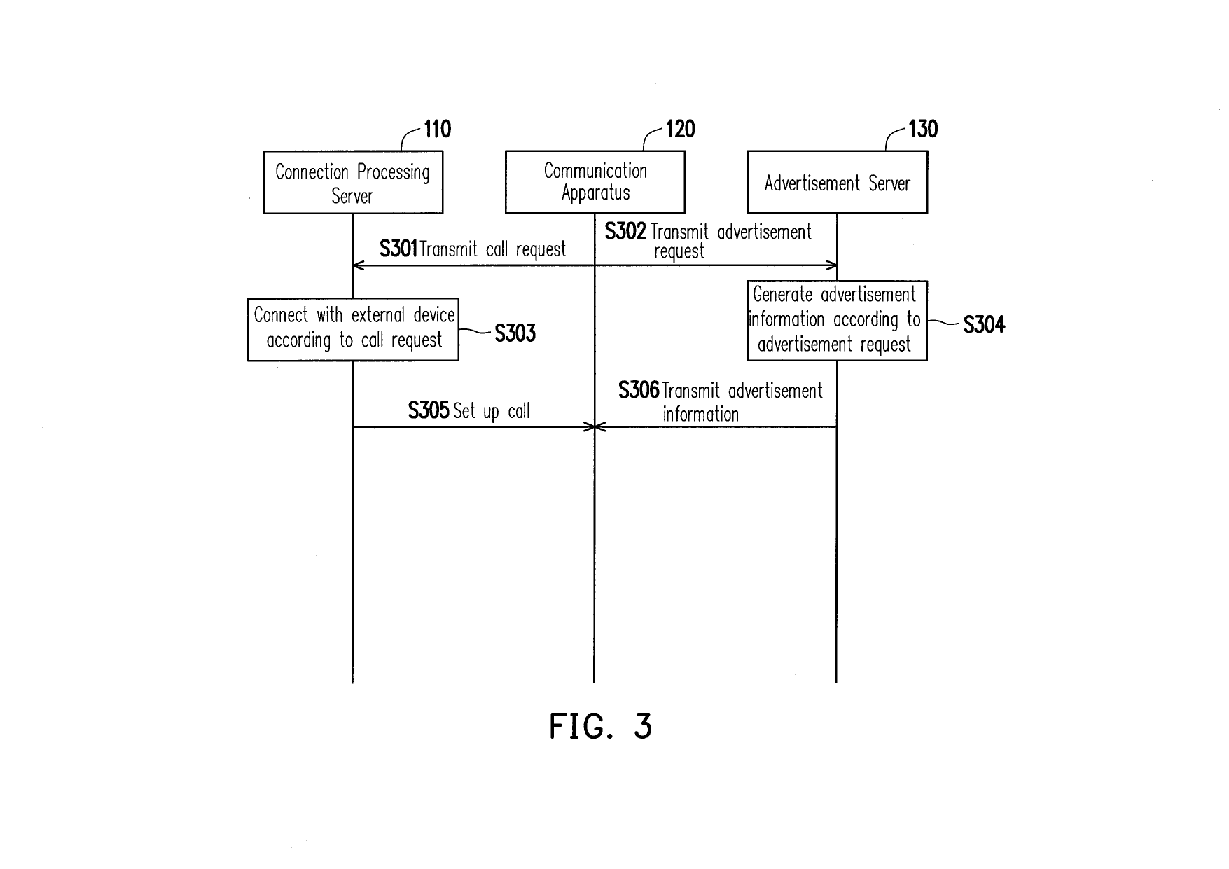

FIG. 3 is a timing flow diagram of an outbound call setup according to an embodiment of the invention, which further elaborates on a detailed implementation of Step S201 to Step S202 in the embodiment depicted in FIG. 2. With reference to FIG. 3, when the communication apparatus 120 needs to set up an outbound call (e.g. when the user operates an outbound phone call), the communication apparatus 120 transmits a call request to the connection processing server 110 (Step S301), and at the same time transmits an advertisement request to the advertisement server 130 (Step S302). The advertisement request includes a profile data and/or a positioning data of the communication apparatus 120, for instance. Profile data such as the user's sex, age, and interested ad categories may be set up by the user beforehand and stored in the communication apparatus 120.

When the advertisement server 130 receives the advertisement request, the matching options in a database (not drawn) of the advertisement server 130 can be allocated according to the user profile data and/or the current positioning data of the communication apparatus 120, and an advertisement information can be generated by the advertisement server 130 (Step S304). For example, the database of the advertisement server 130 may include a store that the user is interested in near the location of the communication apparatus 120, and the advertisement option and content of the store can be inserted in the advertisement information. Alternatively, when the advertisement server 130 receives the advertisement request during meal time, the advertisement server 130 can search for discount information of restaurants in the database near the location of the communication apparatus 120, and insert the advertisement content including the discount information in the advertisement information. However, the invention is not limited to the content described heretobefore, and adjustments may be made according to the actual usage of the system. After the advertisement server 130 generates the advertisement information in the aforementioned method, the advertisement information is sent back to the communication apparatus 120 (Step S306).

On the other hand, after the connection processing server 110 receives the call request transmitted from the communication apparatus 120, a connection is made with an external device (not drawn) according to the call request (Step S304), and a call is set up with the external device and the communication apparatus 120 (Step S305). When the communication apparatus 120 assigns a call destination in the call request, i.e. the aforementioned external device, the call may need to be set up through a fee charging network service (e.g. PSTN network). The connection processing server 110 also updates the cost information corresponding to the communication apparatus 120 according to a call duration or by other methods. The steps after the call has been set up can be referenced to the description of Steps S203 to S210 in the embodiment depicted by FIG. 2, and therefore further elaboration is omitted.

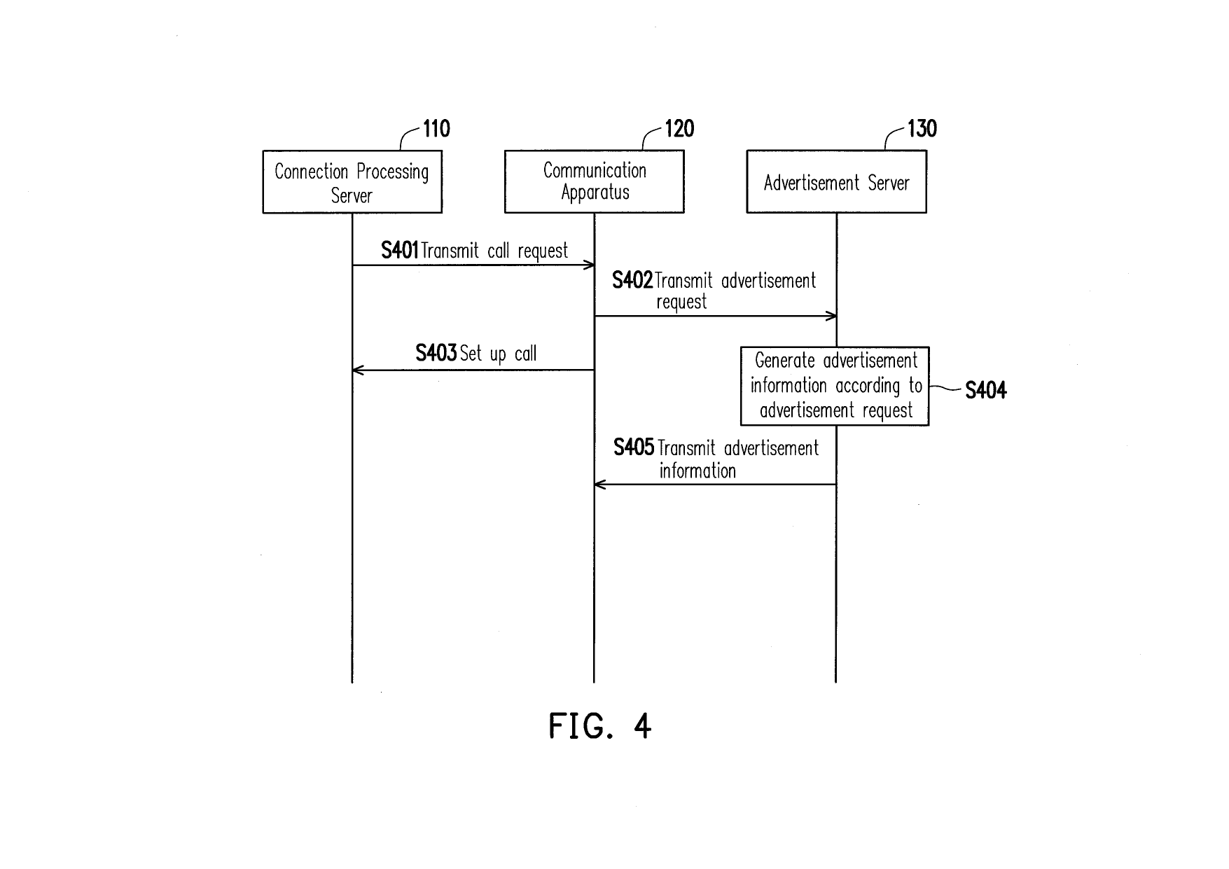

FIG. 4 is a timing flow diagram of an inbound call setup according to an embodiment of the invention, which further elaborates on a detailed implementation of Step S201 to Step S202 in the embodiment depicted in FIG. 2. Referring to FIG. 4, the connection processing server 110 receives a request transmitted from an external device (not drawn) seeking to set up a call with the communication apparatus 120. The connection processing server 110 then transmits a call request to the communication apparatus 120.

After the communication apparatus 120 receives the call request, the advertisement request is transmitted to the advertisement server 130 (Step S402). After the advertisement server 130 receives the advertisement request, the method described by the embodiment depicted in FIG. 3 may be used to generate the advertisement information (Step S404), and the advertisement information is sent back to the communication apparatus 120 (Step S404). On the other hand, after the communication apparatus 120 receives the call request from the connection processing server 110, the call is set up through the connection processing server 110 (Step S403). The steps after the call has been set up can be referenced to the description of Steps S203 to S210 in the embodiment depicted by FIG. 2, and therefore further elaboration is omitted. In other words, whether the call is inbound or outbound, the communication apparatus 120 proactively transmits the advertisement request to the advertisement server 130 (Step S302 in FIG. 3 and Step S402 in FIG. 4).

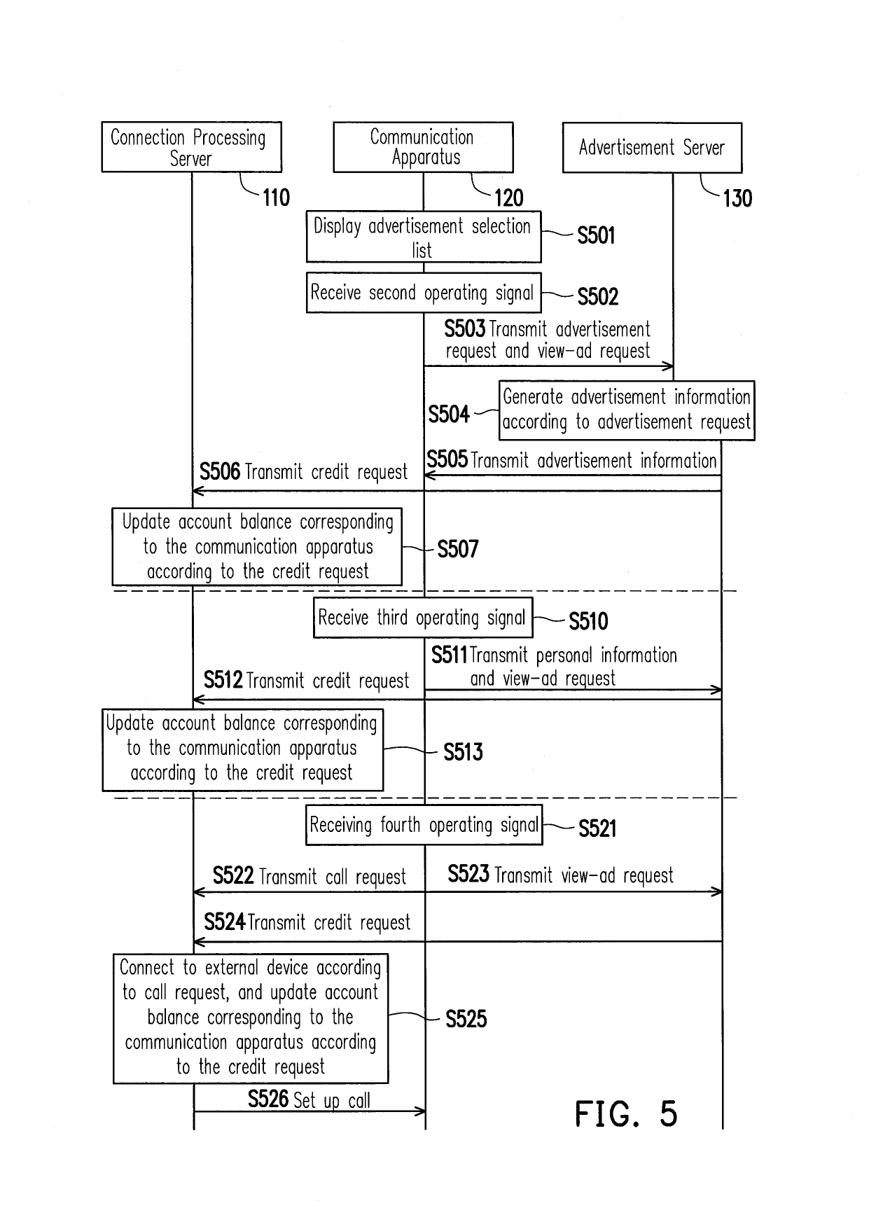

Besides the methods aforementioned, other than user self-select, or advertisement display when the call is in the terminated state, the invention also provides other methods for the user of the communication apparatus 120 to view advertisements in order to increase the account credit. FIG. 5 is a timing flow diagram for updating a user view-ad activity according to an embodiment of the invention. With reference to FIG. 5, in the present embodiment, each time the communication apparatus 120 receives the advertisement information (e.g. Step S102 in FIG. 1), a plurality of records corresponding to the advertisement contents in the advertisement information may be retrieved and stored locally in a advertisement selection list, so subscriber can operate and watch them even when the communication apparatus 120 is offline. Advertisement selection list includes viewed advertisement list and online advertisement selection list retrieved from advertisement server.

The user can operate the communication apparatus 120 to display the advertisement selection list (Step S501) and select one of the records in the advertisement selection list. That is, when the communication apparatus 120 receives a second operation signal (Step S502), the communication apparatus 120 transmits the advertisement request and the view-ad request to the advertisement server 130 (Step S503). After the advertisement server 130 receives the view-ad request, an advertisement content corresponding to the record in the advertisement request is generated and sent back to the communication apparatus 120, such that the communication apparatus 120 can display the corresponding advertisement content (Step S505). Moreover, when the advertisement server 130 receives the view-ad request, the advertisement server 130 composes a credit request and transmits the credit request to the connection processing server 110 according to the view-ad request (Step S506), and updates the account balance information corresponding to the communication apparatus 120. For example, credit point corresponding to the advertisement content selected by the user is added (Step S507).

It should be noted that, in another embodiment, when the communication apparatus 120 retrieve advertisement selection list and stores them in advertisement selection list, not only are the advertisement selection records stored, but the advertisement contents corresponding to the records may be also pre-fetched and stored at the same time depending on user preference settings at the communication apparatus 120. When the communication apparatus 120 receives the second operating signal corresponding to one of the records (user selects one of the records), the communication apparatus 120 can directly display the advertisement content corresponding to the record. The view-ad request is transmitted to the advertisement server 130 when communication apparatus 120 is online. In another implementation, the communication apparatus 120 stores advertisement contents with smaller data size, such as text and still images. For advertisement contents with large data size, such as advertisement contents including interactive audio and video data, Steps S503 to S507 in FIG. 3 are executed again to request the advertisement contents from the advertisement server 130. However, the foregoing description does not limit the possible implementations, which can be adjusted according to actual circumstances.

When the communication apparatus 120 displays the advertisement information, user of the communication apparatus 120 has the options to perform multiple interactions with the provided advertisement content, in order to earn more credit points. Referring to FIG. 5, Steps S510-S513 and Steps S521-S526 respectively represent the steps of two processes that user may make to earn credit points. When the user is interested in the advertisement content currently displayed by the communication apparatus 120, such as in purchasing the merchandise shown in the advertisement content, and the user wants to receive more information or needs a customer representative, the user can operate the communication apparatus 120 to transmit a personal information of the user to the advertisement server 130, such as the preset name and contact information.

In other words, the communication apparatus 120 receives a third operating signal from the user operation (Step S510). After receiving the third operating signal, the personal information of the user is transmitted to the advertisement server 130 (Step S511). After the advertisement server 130 receives the personal information, the personal information of the user of the communication apparatus 120 can be forwarded to the advertisement sponsor. Accordingly, the advertisement sponsor can actively contact the user of the communication apparatus 120. When the communication apparatus 120 transmits the personal information to the advertisement server 130, and sends the view-ad request to the advertisement server 130 at the same time (Step S511), the advertisement server 130 transmits the account credit request to the connection processing server 110 according to the view-ad request (Step S512). After receiving the credit request, the connection processing server 110 can update the account balance information corresponding to the communication apparatus 120 according to the credit request, such as increasing the earning credit points corresponding to the communication apparatus 120.

On the other hand, when the user is interested in the advertisement content currently displayed by the communication apparatus 120, the advertisement sponsor can be directly called by operating the communication apparatus 120. For example, when the advertisement content resembles a restaurant, the user can directly call the restaurant for a reservation by operating the communication apparatus 120. That is, the communication apparatus 120 receives a fourth operating signal by the user operation (Step S521). After the communication apparatus 120 receives the fourth operating signal, the call request is transmitted to the connection processing server 110 (Step S522), and the view-ad request is transmitted to the advertisement server 130 at the same time (Step S523).

The advertisement server 130 transmits the credit request to the connection processing server 110 according to the view-ad request. The connection processing server 110 can update the account balance corresponding to the communication apparatus 120 according to the credit request, such as increasing the earning credit points corresponding to the communication apparatus 120. At the same time, according to the call request, the connection processing server 110 connects with the external device, which in this case is the advertisement sponsor, such that a call is set up with the external device and the communication apparatus 120 (Steps S522, S525, and S526). Accordingly, the user can contact the advertisement sponsor swiftly while accumulating the credit points at the same time.

It should be noted that, the aforementioned Steps S510-S513 and Steps S521-S26 are not limited to being employed after the operations of Steps S501-S507, or the operations after displaying the advertisement selection list. The flow processes of Steps S510-S513 and Steps S521-S526 are suitable for all cases in which the aforementioned communication apparatus 120 display the advertisement contents or states corresponding thereto. In Step S104 of FIG. 1, for example, adjustments may be made in an actual implementation according to the services the advertisement sponsors provide.

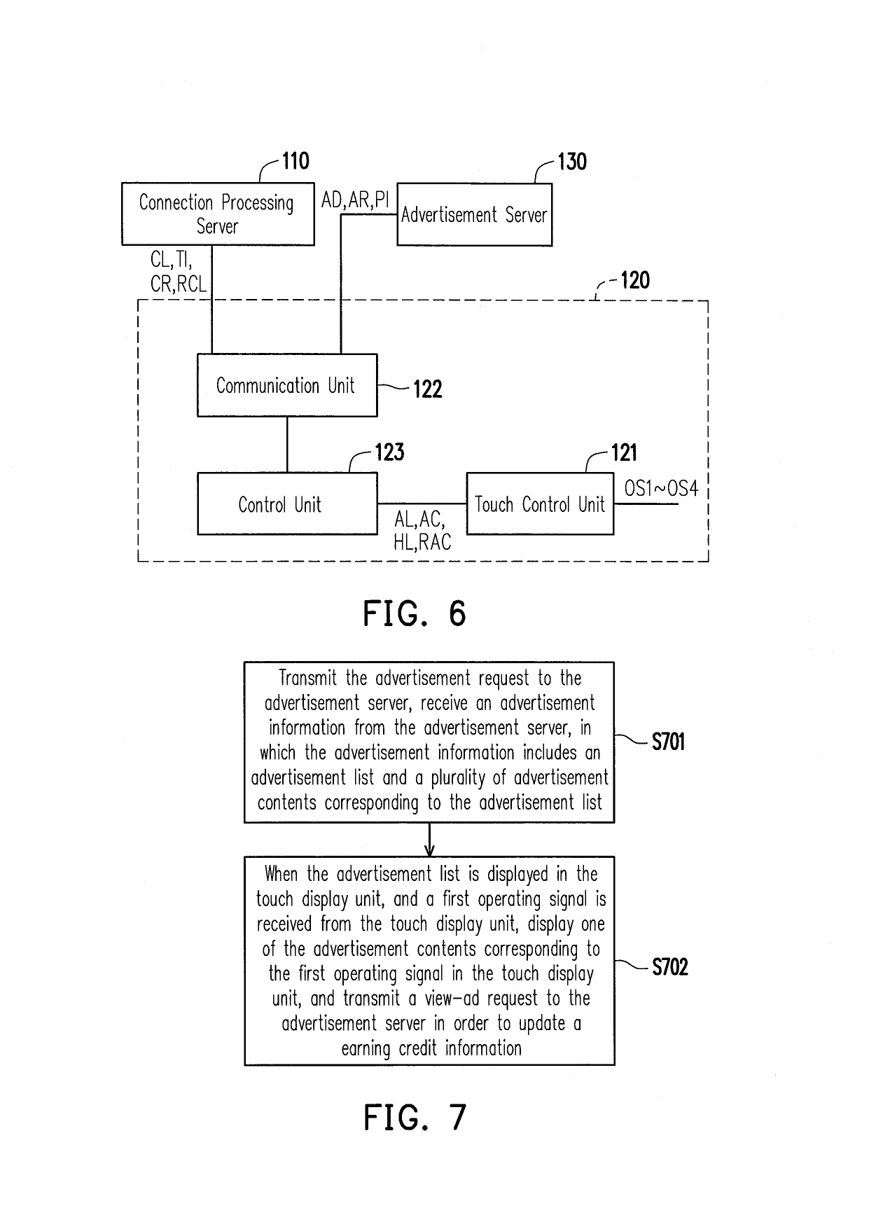

Furthermore, some embodiments of the invention provide a communication apparatus. FIG. 6 is a block diagram of a communication apparatus according to an embodiment of the invention. With reference to FIG. 6, a communication apparatus 120 includes a touch display unit 121, a communication unit 122, and a control unit 123. The control unit 123 is connected to the communication unit 122 and the touch display unit 121. Moreover, the control unit 123 is connected to a connection processing server and an advertisement server through the communication unit 122. The control unit 123 transmits an advertisement request AR to the advertisement server 130 through the communication unit 122, and receives an advertisement information AD from the advertisement server 130. The advertisement information AD includes an advertisement list AL and a plurality of advertisement contents AC corresponding to the advertisement list AL. When the control unit 123 controls the touch display unit 121 to display the advertisement list AL, and the control unit 123 receives a first operating signal OS1 from the touch display unit 121, the control unit 123 displays one of the advertisement contents AC corresponding to the first operating signal OS1, and transmits a view-ad request TI to the advertisement server so as to update a account credit corresponding to the communication apparatus 120.

Continuing reference to FIG. 6, in one embodiment of the invention, the communication unit 122 connects to the connection processing server 110 through an external connection, and sets up a call CL through the connection processing server 110. When the communication unit 110 sets up the call CL, the control unit 123 receiving the advertisement information AD from the advertisement server and the call CL is in a terminated state, the control unit 123 controls the touch display unit 121 to display the advertisement list AL. Moreover, when the control unit 123 receives the first operating signal 051 from the touch display unit 121, the control unit 123 displays one of the advertisement contents AC corresponding to the first operating signal OS1, and transmits a view-ad request TI to the connection processing server 110 in order to update the earning credit points.

When the call CL is an outbound call, the communication unit 112 transmits a call request CR to the connection processing server 110, so that the call CL is set up with an external device (not drawn) through the connection processing server 110. The control unit 123 simultaneously transmits the advertisement request AR to the advertisement server 130, in which the advertisement request AR includes a profile data and/or a positioning data of the communication apparatus 120. When the call CL is an inbound call, the communication unit 122 receives the call request CR from the connection processing server 110, so that the communication unit 122 sets up the call CL with the external device through the connection processing server 110.

It should be noted that, in one embodiment of the invention, the communication apparatus 120 further includes a memory unit (not drawn) connected to the control unit 123 and configured for storing an advertisement selection list HL. The advertisement selection list HL includes a plurality of records corresponding to the advertisement contents. When the control unit 123 controls the touch display unit 121 to display the advertisement selection list HL, and receives a second operating signal 0S2 corresponding to one of the records in the advertisement selection list HL, the control unit 123 transmits the advertisement request AR including the record to the advertisement server 130, and transmits the view-ad request TI to the advertisement server 130 at the same time. The control unit 123 receives the advertisement information AD sent back by the advertisement server 130, in which the advertisement information AD includes an advertisement content RAC corresponding to the record. Moreover, the control unit 123 controls the touch display unit 121 to display the corresponding advertisement content RAC.

When the control unit 123 controls the touch display unit 121 to display one of the advertisement contents AC or the corresponding advertisement content RAC, and receives a third operating signal 0S3 from the touch display unit 121, the control unit 123 transmits a personal information PI and the view-ad request to the advertisement server 130. When the control unit 123 controls the touch display unit 121 to display one of the advertisement contents AC or the corresponding advertisement content RAC, and receives a fourth operating signal 0S4 from the touch display unit 121, the control unit 123 controls the communication unit 122 to transmit the call request CR to the connection processing server 110 and transmit the view-ad request TI to the advertisement server 130, so that a call RCL can be set up through the connection processing server 110 with the corresponding advertisement content AC or with an external device (not drawn) of the corresponding advertisement content RAC.

The communication apparatus 120 may be a handheld electronic device such as a smartphone or a tablet computer having the call and display functions, in which each component may be respectively implemented by physical circuits, or implemented by a processor executing program codes. For example, the control unit 123 can be implemented by a processor executing an application program, although the invention is not limited to the foregoing implementation. The detailed implementation of the communication apparatus 120 can be referenced to the aforementioned embodiments, and therefore further elaboration is omitted.

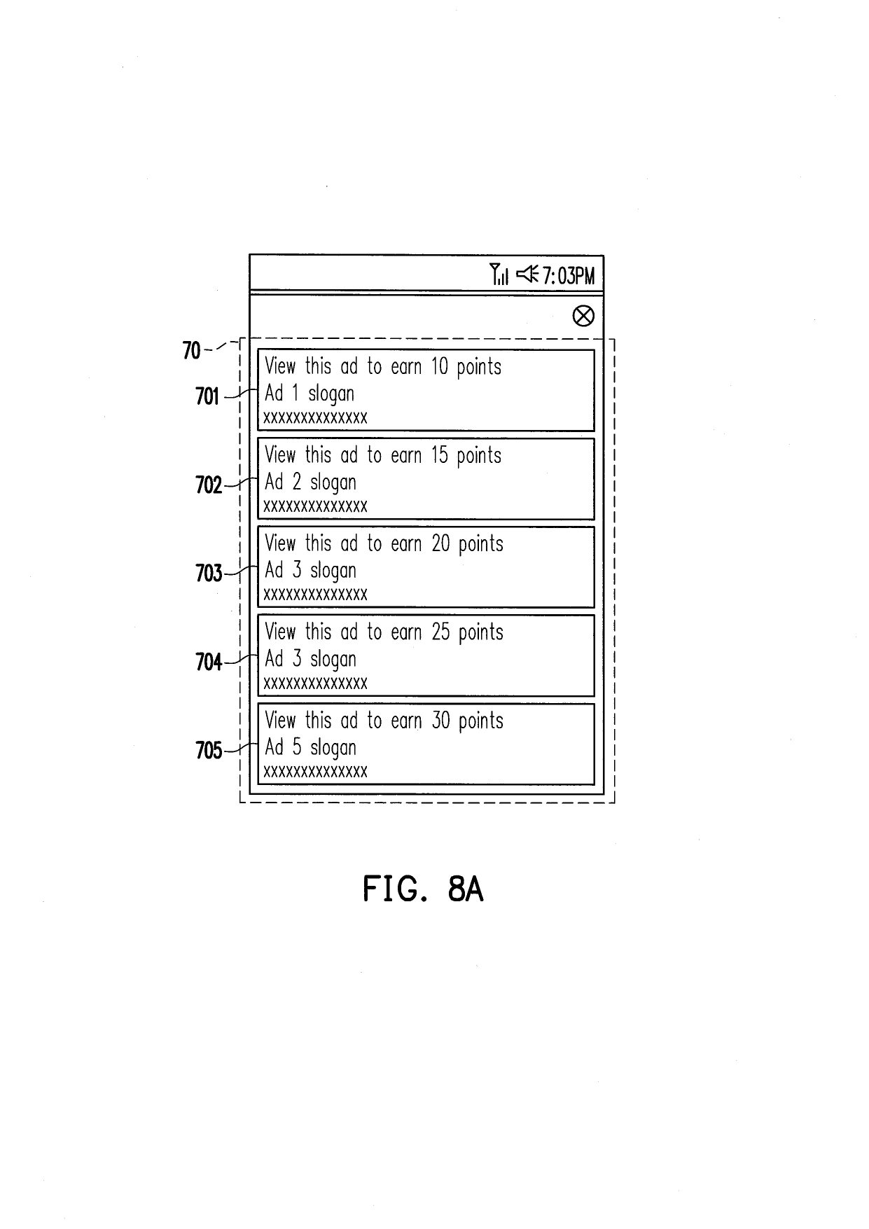

Furthermore, some embodiments of the invention provide a communication method. FIG. 7 is a flow diagram of a communication method according to an embodiment of the invention. With reference to FIG. 7, an advertisement request is transmitted to the advertisement server, and an advertisement information is received from the advertisement server. The advertisement information includes an advertisement list and a plurality of advertisement contents corresponding to the advertisement list (Step S701). Thereafter, when the advertisement list is displayed in the touch display unit, and a first operating signal is received from the touch display unit, one of the advertisement contents corresponding to the first operating signal is displayed, and a view-ad request is transmitted to the advertisement server in order to update a earning credit (Step S702). The detailed implementation can be referenced to the aforementioned embodiments, and therefore further elaboration is omitted.

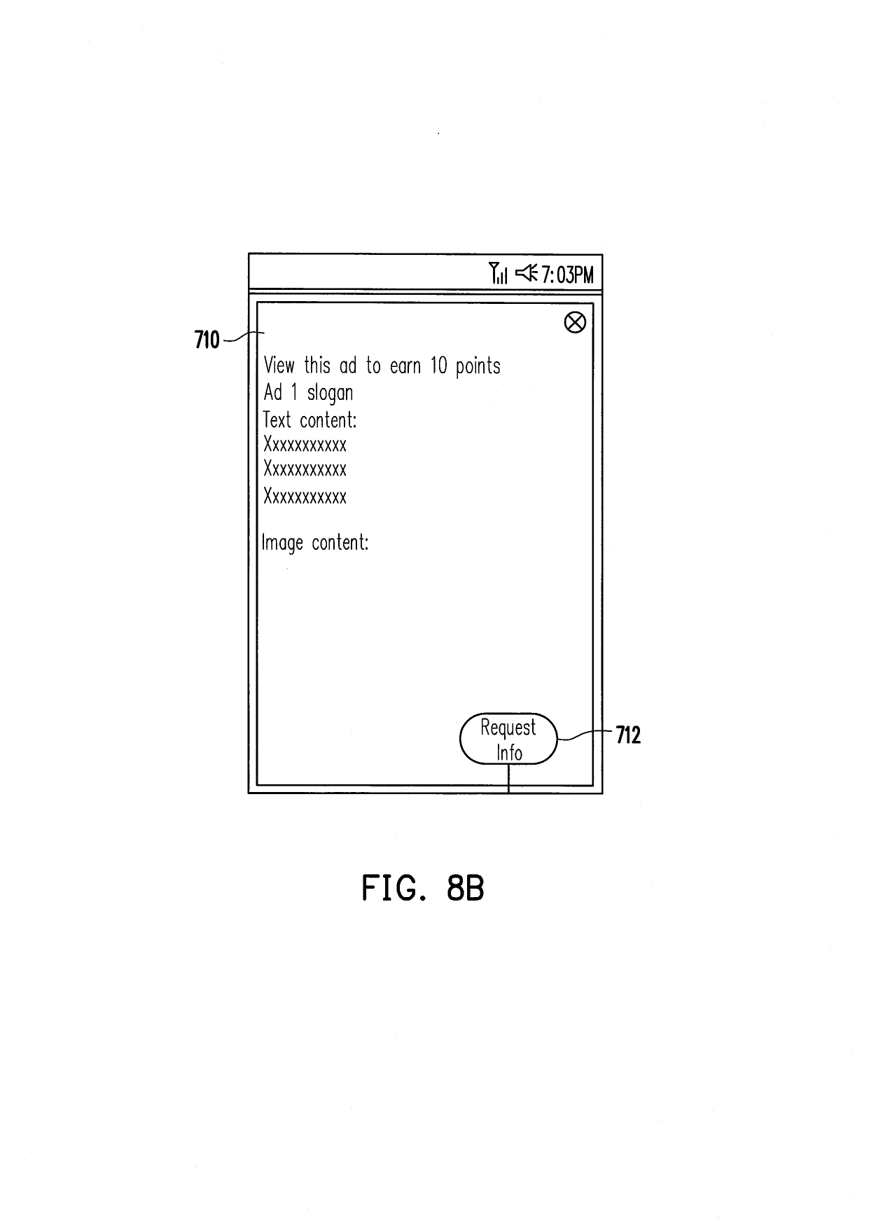

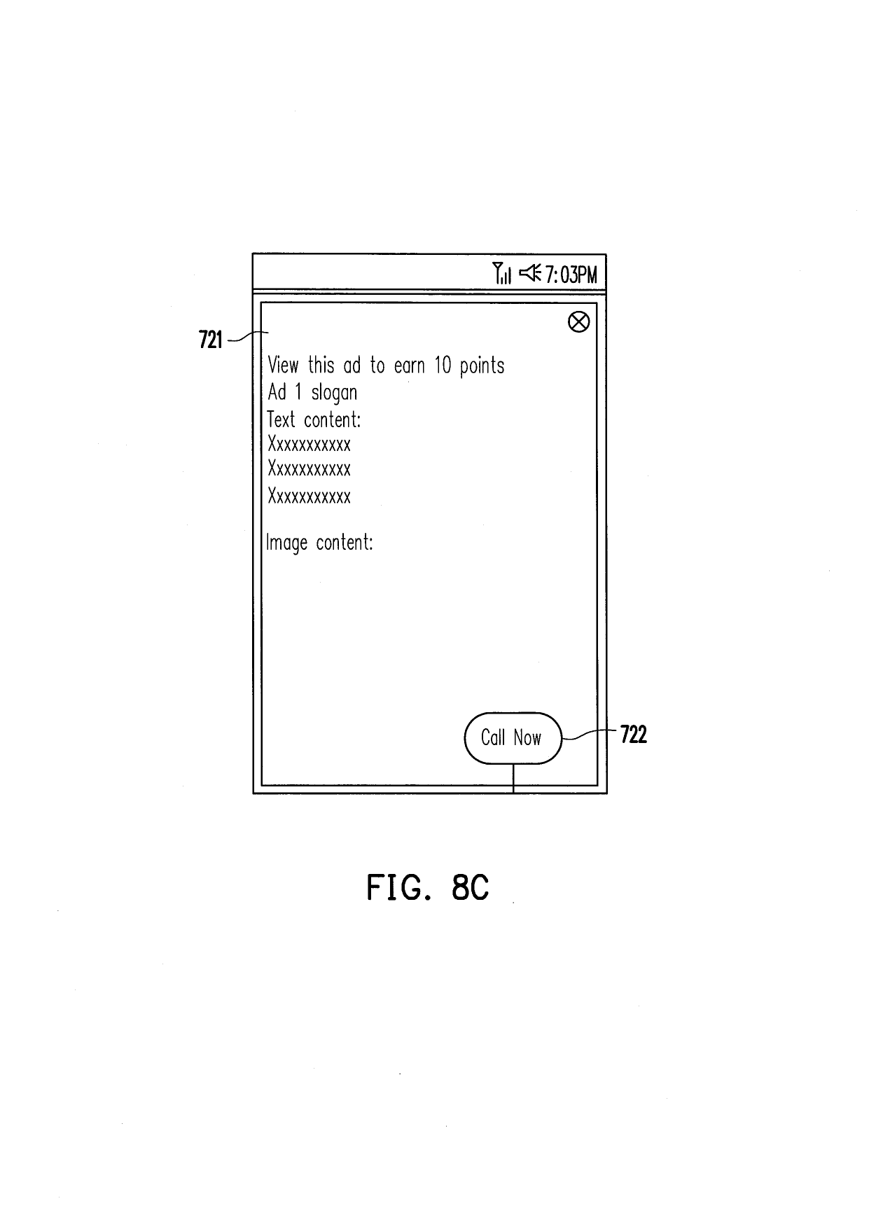

FIGS. 8A, 8B, and 8C illustrate implementations to display an advertisement list and an advertisement information according to an embodiment of the invention. FIG. 8A is an implementation to display the advertisement list. Referring to FIG. 8A, an advertisement list 70 includes advertisement options 701-705. Descriptive words such as the advertisement slogans and brief introductions, as well as the credit points corresponding to the credit points obtainable when the user selects the advertisements are included in the advertisement options 701-705. The advertisement list of FIG. 8A can be displayed when the call is terminated (e.g. embodiment shown in FIG. 2), by popping up when the user selects, or can be displayed on dial pads or side columns of other application programs, and the invention is not limited thereto. FIG. 8B is an implementation to display the advertisement content, in which besides an advertisement content 710, a key 712 is also displayed. When the user presses the key 712, the communication apparatus 120 receives the corresponding third operating signal, and accordingly transmits the personal information of the user to the advertisement server 130. FIG. 8B is another implementation to display the advertisement content, in which besides an advertisement content 721, a key 722 is also displayed. When the user presses the key 722, the communication apparatus 120 receives the corresponding fourth operating signal, and accordingly sets up a call with the advertisement sponsor.

In view of the foregoing, embodiments of the invention provide a communication system, apparatus, and method thereof, such that the user of the communication apparatus can lower telephone calling costs by selecting advertisements to earn credit points. The communication apparatus can receive advertisement information from the advertisement server according to the user preset profile and the current location of the communication apparatus, and thereby provide the user with advertisement contents of possible interest. Moreover, by accumulating credit points through ad interactions such as the user selecting the advertisements, viewing the advertisements, leaving personal information, or by direct calling the advertisement sponsors, effective advertising effects can be achieved, while at the same time, the user can obtain the needed information, service, or merchandise.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A communication system, comprising:
a connection processing server;
an advertisement server;
a communication apparatus, connected to the connection processing server and the advertisement server, the communication apparatus configured for transmitting an advertisement request to the advertisement server and receiving an advertisement information from the advertisement server, wherein the advertisement information comprises an advertisement list and a plurality of advertisement contents corresponding to the advertisement list;
when the communication apparatus displays the advertisement list and receives a first operating signal, the communication apparatus displays one of the advertisement contents corresponding to the first operating signal and transmits a view-ad request to the advertisement server; and
when the advertisement server receives the view-ad request, the advertisement server transmits a credit request according to the view-ad request to the connection processing server to update a account balance corresponding to the communication apparatus.

2. The communication system of claim 1, wherein:
the advertisement request comprises a profile data and/or a positioning data of the communication apparatus; and
the advertisement server receives the advertisement request and transmits the advertisement information to the communication apparatus according to the profile data and/or the positioning data.

3. The communication system of claim 1, wherein:
the communication apparatus sets up a call through the connection processing server; and
when the call is in a terminated state, the communication apparatus displays the advertisement list.

4. The communication system of claim 3, wherein:
the terminated state of the call is a call setup failure or a call got hung up.

5. The communication system of claim 3, wherein:
when the call is an outbound call, the communication apparatus transmits a call request to the connection processing server, so as to set up the call with an external device through the connection processing server; and
the communication apparatus simultaneously transmits the advertisement request to the advertisement server.

6. The communication system of claim 3, wherein:
when the call is an inbound call, the connection processing server transmits a call request to the communication apparatus, so that the communication apparatus sets up the call with an external device through the connection processing server; and
the communication apparatus simultaneously transmits the advertisement request to the advertisement server.

7. The communication system of claim 1, wherein:
the communication apparatus stores in a advertisement selection list a plurality of records corresponding to the advertisement contents in the advertisement information, and when the communication apparatus displays the advertisement selection list and receives a second operating signal corresponding to one of the records in the advertisement selection list, the communication apparatus transmits the advertisement request and the view-ad request comprising the record to the advertisement server;
when the advertisement server receives the advertisement request, the advertisement information is sent back to the communication apparatus, wherein the advertisement information comprises a corresponding advertisement content of the record;
when the advertisement server receives the view-ad request, the advertisement server transmits the credit request to the connection processing server to update the account balance corresponding to the communication apparatus; and
when the communication apparatus receives the advertisement information, the corresponding advertisement content is displayed.

8. The communication system of claim 7, wherein:
when the communication apparatus displays one of the advertisement contents or the corresponding advertisement content, and the communication apparatus receives a third operating signal, the communication apparatus transmits a personal information and the view-ad request to the advertisement server.

9. The communication system of claim 7, wherein:
when the communication apparatus displays one of the advertisement contents or the corresponding advertisement content, and the communication apparatus receives a fourth operating signal, the communication apparatus transmits the call request to the connection processing server and transmits the view-ad request to the advertisement server; and
according to the call request, the connection processing server sets up a corresponding call with the corresponding advertisement content or with an external device of the corresponding advertisement content.

10. The communication system of claim 1, wherein:
the credit request comprises a earning credit points corresponding to the communication apparatus; and
when the connection processing server receives the credit request, the connection processing server updates the account balance to increase the earning credit points corresponding to the communication apparatus.

11. A communication apparatus, comprising:
a touch display unit;
a communication unit;
a control unit, connected to the communication unit and the touch display unit, and connected to a connection processing server and an advertisement server through the communication unit, the control unit transmitting an advertisement request to the advertisement server and receiving an advertisement information from the advertisement server, wherein the advertisement information comprises an advertisement list and a plurality of advertisement contents corresponding to the advertisement list; and
when the control unit controls the touch display unit to display the advertisement list, and the control unit receives a first operating signal from the touch display unit, the control unit displays one of the advertisement contents corresponding to the first operating signal, and transmits a view-ad request to the advertisement server so as to update a account credit corresponding to the communication apparatus.

12. The communication apparatus of claim 11, wherein: the advertisement request comprises a profile data and/or a positioning data of the communication apparatus.

13. The communication apparatus of claim 11, wherein:
the communication unit sets up a call through the connection processing server; and
when the call is in a terminated state, the control unit controls the touch display unit to display the advertisement list.

14. The communication apparatus of claim 13, wherein:
the terminated state of the call is a call setup failure or a call got hung up.

15. The communication apparatus of claim 13, wherein:
when the call is an outbound call, the communication unit transmits a call request to the connection processing server, so as to set up the call with an external device through the connection processing server, and the control unit simultaneously transmits the advertisement request to the advertisement server.

16. The communication apparatus of claim 13, wherein:
when the call is an inbound call, the communication unit receives a call request from the connection processing server, so that the communication unit sets up the call with an external device through the connection processing server, and the control unit simultaneously transmits the advertisement request to the advertisement server.

17. The communication apparatus of claim 11, further comprising:
a memory unit connected to the control unit, configured for storing a advertisement selection list comprising a plurality of records corresponding to the advertisement contents;
when the control unit controls the touch display unit to display the advertisement selection list, and receives from the touch display unit a second operating signal corresponding to one of the records in the advertisement selection list, the control unit transmits the advertisement request and the view-ad request comprising the record to the advertisement server; and
the control unit receives the advertisement information sent back by the advertisement server, wherein the advertisement information comprises an advertisement content corresponding to the record, and the control unit controls the touch display unit to display the corresponding advertisement content.

18. The communication apparatus of claim 17, wherein:
when the control unit controls the touch display unit to display one of the advertisement contents or the corresponding advertisement content, and receives a third operating signal from the touch display unit, the control unit transmits a personal information and the view-ad request to the advertisement server.

19. The communication apparatus of claim 17, wherein:
when the control unit controls the touch display unit to display one of the advertisement contents or the corresponding advertisement content, and receives a fourth operating signal from the touch display unit,
the control unit controls the communication unit to transmit the call request to the connection processing server, so as to set up a corresponding call with the corresponding advertisement content or with an external device of the corresponding advertisement content through the connection processing server, and transmit the view-ad request to the advertisement server.

20. The communication apparatus of claim 11, wherein:
the credit request comprises a earning credit points corresponding to the communication apparatus.

21. A communication method, comprising:
transmitting an advertisement request to an advertisement server, and receiving an advertisement information from the advertisement server, wherein the advertisement information comprises an advertisement list and a plurality of advertisement contents corresponding to the advertisement list; and
when the advertisement list is displayed in a touch display unit, and a first operating signal is received from the touch display unit, displaying one of the advertisement contents corresponding to the first operating signal in the touch display unit, and transmitting a view-ad request to the advertisement server in order to update a earning credit information.

22. The communication method of claim 21, wherein:
the advertisement request comprises a profile data and/or a positioning data.

23. The communication method of claim 21, wherein before the step of receiving the advertisement information from the advertisement server, the method further comprises:
setting up a call through a connection processing server; and
when the call is in a terminated state, controlling the touch display unit to display the advertisement list.

24. The communication method of claim 23, wherein the terminated state of the call is a call setup failure or a call got hung up.

25. The communication method of claim 23, wherein:
when the call is an outbound call, a call request is transmitted to the connection processing server, so as to set up the call with an external device through the connection processing server, and an advertisement request is simultaneously transmitted to the advertisement server.

26. The communication method of claim 23, wherein:
when the call is an inbound call, a call request is received from the connection processing server, so that the call is set up with an external device through the connection processing server.

27. The communication method of claim 21, wherein the step of displaying one of the advertisement contents in the touch display unit further comprises:
storing a record corresponding to the advertisement content in a advertisement selection list in a memory unit;
when controlling the touch display unit to display the advertisement selection list, and receiving from the touch display unit a second operating signal corresponding to one of the records in the advertisement selection list, transmitting the advertisement request and the view-ad request comprising the record to the advertisement server; and
receiving the advertisement information, wherein the advertisement information comprises an advertisement content corresponding to the advertisement request, and controlling the touch display unit to display the corresponding advertisement content.

28. The communication method of claim 27, wherein:
when controlling the touch display unit to display the advertisement content or the corresponding advertisement content, and receiving a third operating signal from the touch display unit, a personal information and the view-ad request are transmitted to the advertisement server.

29. The communication method of claim 27, wherein:
when controlling the touch display unit to display one of the advertisement contents or the corresponding advertisement content, and receiving a fourth operating signal from the touch display unit,
the call request is transmitted to the connection processing server, so as to set up a corresponding call with the corresponding advertisement content or with an external device of the corresponding advertisement content, and the view-ad request is simultaneously transmitted to the advertisement server.

30. The communication method of claim 21, wherein:
the account credit request comprises a earning credit point record.
